(19) United States
(12) Patent Application Publication
(10) Pub. No.: US 2008/0105513 A1
(43) Pub. Date: May 8, 2008

(54) STARTING CLUTCH

(76) Inventors: Tomoyuki MIYAZAKI, Fukuroi-shi (JP); Shun Kitahara, Fukuroi-shi (JP); Manabu Sawayanagi, Fukuroi-shi (JP); Masaki Sakai, Fukuroi-shi (JP); Yosuke Ikeda, Fukuroi-shi (JP)

Correspondence Address: MILES & STOCKBRIDGE PC, 1751 PINNACLE DRIVE, SUITE 500, MCLEAN, VA, 22102-3833, US

(21) Appl. No.: 11/929,382

(22) Filed: Oct. 30, 2007

(30) Foreign Application Priority Data
Nov. 2, 2006 (JP) 2006-299089

(51) Int. Cl. F16D 13/22; F16D 67/00; F16D 67/02

(52) U.S. Cl. 192/113.34; 192/3.57; 192/12 R

(57) ABSTRACT

The present invention provides a starting clutch disposed between an engine and a transmission, comprising a clutch drum to which a rotation driving force is inputted from the engine and which holds a plurality of outer plates for an axial sliding movement, a hub member which is disposed in an inner diameter direction of the clutch drum and which holds a plurality of inner plates arranged alternately with the plurality of the outer plates for an axial movement, and a piston disposed within the clutch drum and adapted to apply an urging force to the outer plates and the inner plates to engage these plates with each other, and wherein the hub member is fitted on an input shaft of the transmission for an axial movement and an outer end portion of the clutch drum extending toward the engine is supported by a crankshaft of the engine and an inner end portion of the clutch drum extending toward the transmission is supported by an outer periphery of the hub member.

### BACKGROUND OF THE INVENTION

1. Field of the Invention

The present invention relates to a starting clutch which can be used in place of a torque converter for a motor vehicle and the like.

2. Description of the Related Art

In the past, in automatic transmissions, the starting of a vehicle has been achieved through torque transmission of a torque converter. The torque converter has been mounted on many vehicles since the torque converter serves to enhance reduction in fuel consumption of the vehicle and to amplify the torque and also provides smooth torque transmission during the increase and/or decrease of the torque.

On the other hand, the torque converter has disadvantages that a slip amount is increased during the increase and/or decrease of the torque and that efficiency is relatively bad.

Thus, in recent years, it has been proposed that a starting clutch is used in place of the torque converter and it has also been implemented that, in a low speed range, the torque is amplified by increasing a gear ratio and by increasing the number of transmission stages.

In general, the starting clutch includes a wet type multi-plate clutch housed in a clutch drum. In the multi-plate clutch, friction plates as friction engaging elements at an output side and separator plates as friction engaging elements at an input side are alternately arranged along an axial direction. With this arrangement, when the friction plates and the separator plates are engaged with each other by an urging force of a piston, a power can be transmitted.

In recent years, in order to further enhance the reduction in fuel consumption, it has been sought that a lock-up clutch of the torque converter is tightened or engaged from the low speed. However, due to insufficient capacity of the lock-up clutch and a heat resistive property of the lock-up clutch, there is a limitation in the reduction of fuel consumption achieved by the lock-up engagement from the low speed. Thus, for example, as shown in Japanese Patent Application Laid-open No. 2000-274453, it has been proposed to use a starting clutch utilizing a wet type multi-plate clutch in place of the torque converter.

In the starting clutch disclosed in the above-mentioned Japanese Patent Application Laid-open No. 2000-274453, although a housing is fitted on a crankshaft of an engine, since a clutch portion is supported by an input shaft at a transmission side, supporting conditions of the clutch portion deviated from each other between the crankshaft of the engine and the transmission side, thereby causing a problem regarding an anti-vibration property and an assembling ability.

### SUMMARY OF THE INVENTION

Accordingly, an object of the present invention is to provide a starting clutch having excellent rotating performance and an excellent heat resistive ability, which can easily be used in place of a torque converter and in which an assembling ability of the starting clutch to a transmission and an engine is enhanced.

To achieve the above object, the present invention provides a starting clutch disposed between an engine and a transmission, comprising a clutch drum to which a rotation driving force is inputted from the engine and which holds a plurality of outer plates for an axial sliding movement, a hub member which is disposed in an inner diameter direction of the clutch drum and which holds a plurality of inner plates arranged alternately with the plurality of the outer plates for an axial movement, and a piston disposed within the clutch drum and adapted to apply an urging force to the outer plates and the inner plates to engage these plates with each other, and wherein the hub member is fitted on an input shaft of the transmission for an axial movement and an outer end portion of the clutch drum extending toward the engine is supported by a crankshaft of the engine and an inner end portion of the clutch drum extending toward the transmission is supported by an outer periphery of the hub member.

According to the starting clutch of the present invention, the following effects can be obtained. The centering between the input shaft of the transmission and the crankshaft of the engine can be achieved, and, thus, a high accurate assembling ability capable of absorbing an axial attachment error can be obtained.

Further, since the clutch drum at the driving side is positively supported by the crankshaft and the input shaft of the transmission, starting performance capable of enhancing rotating accuracy and enhancing a judder preventing ability and reduction of wear in rotating parts can be obtained.

Further, by providing two independent hydraulic circuits including a hydraulic circuit for controlling the piston and a hydraulic circuit for supplying the lubricating oil, the replacement between the starting clutch of the present invention and an existing torque converter can easily be made.

Further features of the present invention will become apparent from the following description of an exemplary embodiment with reference to the attached drawing.

### BRIEF DESCRIPTION OF THE DRAWINGS

FIGURE is an axial sectional view showing a starting clutch according to an embodiment of the present invention.

### DESCRIPTION OF THE EMBODIMENTS

Now, an embodiment of the present invention will be fully described with reference to the accompanying drawing. Incidentally, it should be noted that the illustrated embodiment is merely exemplary and various changes can be made within the scope of the present invention.

FIGURE is an axial sectional view showing a starting clutch according to an embodiment of the present invention. The starting clutch 10 includes a clutch drum 1 and a wet type multi-plate clutch 30 housed within the clutch drum. The wet type multi-plate clutch 30 comprises substantially annular friction plates (inner plates) 3 as friction engaging elements at an output side and substantially annular separator plates (outer plates) 4 as friction engaging elements at an input side, which plates are arranged alternately along an axial direction within the clutch drum 1. Within one axial end (open end) of the clutch drum 1, a substantially annular backing plate 6 is fixedly supported by a substantially annular stop ring 5 in the axial direction, thereby holding the separator plates 4.

The annular clutch drum 1 is provided at its inner periphery with a central cylindrical portion 32 and is also provided at its outer periphery with a drum portion 34 opposed to the cylindrical portion 32 in a radial direction. The drum portion 34 is provided at its inner periphery with a spline portion 39 with which the separator plates 4 are engaged for an axial sliding movement. At an axial opposite end of the cylindrical portion 32, there is provided a protruded portion 33 which is fitted into a recessed portion 38 of a crankshaft 11 of an engine (not shown). Further, the cylindrical portion 32 is fitted, at its inner periphery, on an input shaft 16 connected to a transmission (not shown) through a hub member 2 which will be described later.

In the illustrated embodiment, although the wet type multi-plate clutch 30 is constituted by three friction plates 3 and four separator plates 4, it should be noted that the number of such friction engaging elements at the input and output sides can be changed voluntarily in accordance with the required torque. Further, a substantially annular friction material 35 or a plurality of friction material segments is fixed to on both axial surfaces of the friction plate 3 by an adhesive. Further, a friction-material 35 may be fixed to the separator plate (outer plate) 4 or friction materials 35 may be fixed to one surface of the friction plate (inner plate) 3 and one surface of the separator plate 4 alternately.

In FIGURE, at the open end portion of the clutch drum 1 within the clutch drum 1, a piston 8 is fitted on the outer periphery of the cylindrical portion 32 for an axial sliding movement, and a hydraulic chamber 31 for applying oil pressure to the piston 8 is defined between the piston 8 and the clutch drum 1. At opposite side of the piston 8 from the hydraulic chamber 31, a plate 70 is secured to the cylindrical portion 32. An axial one end of a spring 9 is secured to the plate 70. The other axial end of the spring 9 abuts against the piston 8 to apply a predetermined urging force, thereby always biasing the piston 8 toward the hydraulic chamber 31 i.e. toward a disengaging or releasing direction of the clutch. Here, although the spring 9 is shown as a coil spring having predetermined elasticity, other type of spring may be used. A surface of the piston 8 opposed to the separator plate 4 is provided with a projection 55 protruding toward the axial direction, so that, when the projection 55 urges the central portion of the separator plate 4, the wet type multi-plate clutch 30 is engaged or tightened.

The hub member 2 fitted on the input shaft 16 of the transmission to be rotated integrally with the input shaft 16 is provided at its outer periphery with a spline portion 36. The friction plates 3 are fitted in the spline portion 36 having axial through-holes 37 for an axial sliding movement. Accordingly, a power inputted from the crankshaft 11 is transmitted to the transmission (not shown) through the crankshaft 11, clutch drum 1, wet type multi-plate clutch 30, hub member 2 and input shaft 16.

The clutch drum 1 of the wet type multi-plate clutch 30 is covered by a cover portion 13 which is a part of a housing 12. Further, a damper device 14 as a shock absorbing mechanism for absorbing shock generated during the clutch engagement is provided within the housing 12. The damper device 14 is constituted by a retainer plate 40 for holding a spring 19, and a pawl member 41 attached to an outer periphery of a cylindrical portion 53 of the clutch drum 1 and fitted on the spring 19. The retainer plate 40 is secured to a drive plate 70 by nuts 42. Further, thrust needle bearings 43 are disposed between the clutch drum 1 and the housing 12.

The input shaft 16 of the transmission which is also an output shaft to which the power from the engine is transmitted is provided with an oil supplying path 52 extending in the axial direction. Hydraulic oil supplied from a supply source (not shown) is supplied to the hydraulic chamber 31 which is maintained to an oil-tight condition by a plurality of seal members, through a gap between the input shaft 16 and the cylindrical portion 53 and then through a radial through hole 60 formed in the cylindrical portion 32 of the clutch drum 1.

At an axial one end, the input shaft 16 is provided at its outer periphery with a spline portion into which a cylindrical portion 50 of the hub member 2 is spline-fitted. That is to say, the input shaft 16 can be rotated integrally with the hub member 2. A thrust washer 61 is disposed between the hub member 2 and the cylindrical portion 53 of the clutch drum 1 and the end of the input shaft 16. The thrust washer 61 may be a needle bearing.

As mentioned above, the hub member 2 is fitted on the input shaft of the transmission for the axial sliding movement and the cylindrical portion 32 of the clutch drum 1 is fitted into the cylindrical portion 50 of the hub member 2 through a bearing 51 for a relative rotational movement. A protruded portion 33 of the clutch drum 1 extending toward the engine is supported by the crankshaft 11 of the engine and the cylindrical portion 32 of the clutch drum 1 extending toward the transmission is supported by an outer peripheral surface of the cylindrical portion 50 of the hub member 2.

A cover member 7 is provided at the open end portion of the clutch drum 1. An outer diameter edge portion 63 of the cover member 7 is fitted into the spline portion 39 of the clutch drum 1. Thus, the cover member 7 is rotated together with the clutch drum 1. An inner diameter side of the cover member 7 constitutes a cylindrical portion 62 so that an axial lubricating oil passage 21 is defined between the cylindrical portion and the input shaft 16. An axial end 64 of the cylindrical portion 62 is connected to an oil pump 15 so that the oil pump 15 is operated by a rotation of the cover member 7. The oil pump 15 serves to supply lubricating oil to the starting clutch 10 and the transmission. Further, the oil pump 15 can also supply operating oil to a brake portion (not shown) and a clutch portion (not shown), and the wet type multi-plate clutch 30.

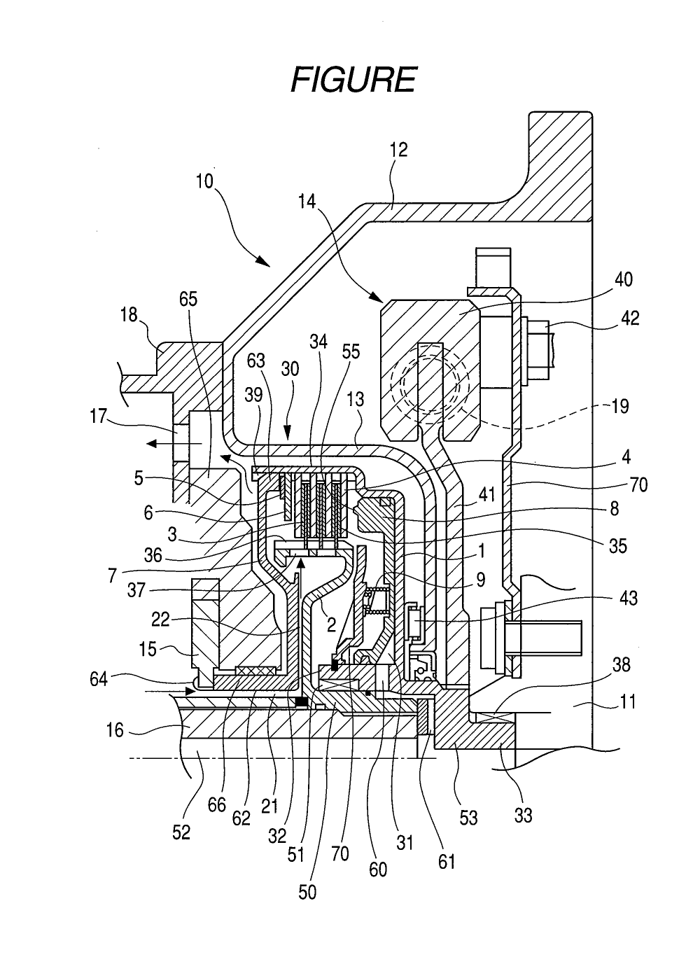

The cover member 7 is rotatably supported by a side wall 65 of the transmission through a needle bearing 66. A radial intermediate portion of the cover member 7 is opposed to an intermediate portion of the hub member 2, thereby defining a narrow passage 22 therebetween. As can be seen from FIG. 1, by providing the cover member 7, the wet type multi-plate clutch 30 is disposed within a substantially closed space. A transmission case 18 disposed in adjacent to the starting clutch 10 is provided at its side wall with an oil returning port 17 extending in the axial direction. The lubricating oil which has lubricated the wet type multi-plate clutch 30 is returned to the interior of the transmission through the oil returning port 17.

Now, an oil path for the lubricating oil lubricating the wet type multi-plate clutch 30 and an oil path for supplying the oil to the hydraulic chamber 31 will be explained. By driving the oil pump 15, the lubricating oil for lubricating the wet type multi-plate clutch 30 flows from the transmission to the wet type multi-plate clutch 30 through the lubricating oil passage 21, a passage 22 defined between the hub member 2 and the cover member 7 and the through hole 37 of the hub member 2, thereby lubricating the wet type multi-plate clutch. Since the clutch drum 1 has no radial through hole, the lubricating oil which has lubricated the wet type multi-plate clutch 30 is directed toward the axial direction i.e. toward the cover member 7 through the spline portion 39 of the clutch drum 1. Thus, if necessary, the cover member 7 may include axial through hole(s) for smoothing the flow of the lubricating oil.

After passed through the cover member 7, the lubricating oil further flows in the axial direction and is returned to the transmission through the oil returning port 17 formed in the side wall of the transmission case 18. The paths through which the lubricating oil flows are shown by the arrows in FIGURE. As can be understood from the above explanation, the lubricating oil is supplied from the axial direction and is discharged in the axial direction.

Next, a hydraulic circuit for controlling the piston 8 will be explained. The hydraulic oil is supplied from the oil supply source (not shown) to an oil supply path 52 formed in the input shaft 16. The oil passed through the oil supply path 52 flows from the gap between the input shaft 16 and the end face of the cylindrical portion 53 and passes through a radial through hole 60 formed in the cylindrical portion 32 of the clutch drum 1 and is supplied to the hydraulic chamber 31. By oil pressure supplied from a hydraulic circuit (not shown), the piston 8 is shifted to the left (FIGURE) to tighten the wet type multi-plate clutch 30.

The above-mentioned oil path for the lubricating oil and the hydraulic circuit for controlling the piston are provided independently from each other. Thus, the replacement between the starting clutch of the present invention and the conventional torque converters having the lock-up clutch can easily be made.

Next, a procedure for attaching the starting clutch of the present invention between the engine and the transmission is as follows. First of all, the starting clutch 10 and the damper device 14 are assembled as a unit which is in turn inserted into the spline portion of the input shaft 16 of the transmission. Then, the housing 12 is secured to the transmission case 18 and then the protruded portion 33 of the clutch drum 1 is inserted into the crankshaft 11 of the engine. Thereafter, by fixing the damper device 14 and the drive plate, in the starting clutch 10, the transmission and the crankshaft 11 of the engine are aligned with each other, and the axial attachment error is absorbed, thereby providing high accurate assembling. Further, since the clutch drum 1 at the drive side is firmly supported by the crankshaft 11 and the input shaft 16 of the transmission, the rotational accuracy is enhanced, and an anti-judder property and wear resisting ability of the rotating parts are also enhanced, thereby providing good starting performance.

As mentioned above, since it is designed so that the hub member 2 is spline-fitted on the input shaft 16, the clutch drum 1 is fitted to the hub member 2 and the clutch drum 1 is supported by the crankshaft 11 of the engine, alignment between the parts of the clutch portion, transmission and engine can be made effectively. Further, since the cylindrical portion 50 of the hub member 2 is held to be pinched between the input shaft 16 and the cylindrical portion 32 of the clutch drum 1, the rotation of the hub member 2 is stabilized.

In the above-mentioned embodiment of the present invention, the starting clutch in which the input side elements and the output side elements are frictionally engaged by an axial load may be, for example, a wet type multi-plate clutch, a single-plate clutch or a conical clutch, and, the spring as the urging means may be, for example, a leaf spring, a coil spring, a wave spring or the like. Further, the urging force of the urging means i.e. spring force and the oil pressure for urging the piston can be set or selected in consideration of various factors such as coefficients of friction of the friction engaging elements of the starting clutch, areas of the friction engaging surfaces and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-299089, filed Nov. 2, 2006, which is hereby incorporated by reference herein in its entirety.

What is claimed is:

1. A starting clutch disposed between an engine and a transmission, comprising:
a clutch drum to which a rotational driving force is inputted from said engine and which is adapted to hold a plurality of outer plates for an axial sliding movement;
a hub member disposed in an inner diameter direction of said clutch drum and adapted to hold inner plates for an axial sliding movement, said inner plates being arranged alternately with said plurality of outer plates along an axial direction; and
a piston provided within said clutch drum and adapted to apply an urging force to said outer plates and said inner plates to engage said plates with each other;
and wherein
said hub member is fitted on an input shaft of said transmission for an axial sliding movement, and an outer end portion of said clutch drum extending toward said engine is supported by a crankshaft of said engine, and an inner end portion of said clutch drum extending toward said transmission is supported by an outer periphery of said hub member.

2. A starting clutch according to claim 1, further comprising an oil pump for supplying lubricating oil to said starting clutch and said transmission, and wherein said oil pump is driven by a drive member provided on said clutch drum.

3. A starting clutch according to claim 2, wherein said oil pump serves to supply operating oil to a brake portion and a clutch portion.

4. A starting clutch according to claim 1, wherein a discharge port for discharging lubricating oil from said starting clutch is formed in a side wall of said transmission.

5. A starting clutch according to claim 1, wherein said outer end portion of said clutch drum is fitted on said crankshaft through a bearing.

6. A starting clutch according to claim 1, further comprising two independent hydraulic circuits including a hydraulic circuit for lubricating oil and a hydraulic circuit for controlling said piston.
